(19) United States
(12) Patent Application Publication
(10) Pub. No.: US 2005/0205481 A1
(43) Pub. Date: Sep. 22, 2005

(54) Oil filter using rare earth magnets for increased filtration

(76) Inventor: Dennis O'Neel, West Des Moines, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 10/803,709

(22) Filed: Mar. 18, 2004

(51) Int. Cl. C02F 1/48

(52) U.S. Cl. 210/223; 210/222; 210/444

(57) ABSTRACT

An oil filter using a rare earth magnet positioned at the bottom or rim of the filter to capture excess metal particles unfiltered by the filter, the oil filter having a cylindrical body, a top adapted to receive oil, a bottom, the rare earth magnet having an extremely strong magnetic force is matingly attached to the bottom or top rim of the oil filter, or the rare earth magnet may be manufactured as part of the body of the filter.

### BACKGROUND OF THE INVENTION

This invention relates to the use of magnets to increase the filtration of oil in an oil filter. When a vehicle is operating, oil flows through the engine of the vehicle and is processed through an oil filter. Though conventional oil filters are able to capture and filter out metallic particles in the oil, many small metal particles are not captured and remain after filtration. Because of these remaining particles, previous oil filters have attempted to use a plurality of magnets to surround the oil filter to capture remaining metal particles. For example, U.S. Pat. No. 6,554,999 to Brunsting; U.S. Pat. No. 5,510,024 to Caiozza; U.S. Pat. No. 5,556,540 to Brunsting; U.S. Pat. No. 5,714,063 to Brunsting; and U.S. Pat. No. 5,932,108 to Brunsting; all disclose an oil filter having a plurality of magnets that surround the cylindrical body of the oil filter.

While a variety of magnets have been used for filtering oil, rare earth magnets have certain desirable features.

Rare earth magnets combine the traits of being physically very small, yet producing a very strong magnetic force. Rare earth magnets are characteristically brittle and porous materials. There are primarily two types of rare earth magnets, samarium cobalt and neodymium iron boron magnets.

The samarium cobalt magnet produces a magnetic field energy of up to 32 MGOe, and can be used in applications where the temperature of an environment reaches 350° C. Typical samarium cobalt magnet applications include use in computer disc drives, sensors traveling wave tubes, linear actuators, satellite systems, and motors where temporary stability is vital. Advantages of using a samarium cobalt magnet include: high resistance to demagnetization, high energy (magnetic strength is strong for its size), and good temperature stability.

The second type of rare earth magnet is neodymium iron boron magnet that has a magnetic field energy of up to 55 MGOe. This provides much stronger magnetizing forces than disclosed in prior art. Neodymium iron boron rare earth magnets usually need to be used in lower temperature applications than samarium cobalt magnet. Applications of the neodymium iron boron magnets include magnetic separators, linear actuators, microphone assemblies, servo motors, DC motors (automotive starters), computer rigid disc drives, hammerbank printers, and speakers. Advantages of using a neodymium iron boron magnet include: very high resistance to demagnetization, high energy for size, good in ambient temperature, moderately priced, and low working temperature for heat applications.

Prior art utilizing rare earth magnets to improve the filtration of oil filters radially wrapped around the center of the filter. By adding this additional layer to the oil filter this approach makes the manufacture and installation in a vehicle more difficult and expensive. Additionally, placement of the rare earth magnet around the center of an oil filter does not provide for maximum filtration. Instead, it is desired that the magnet be placed around the rim of the filter for optimum filtration. Therefore, there is a need in the art to use a rare earth magnet to improve filtration of an oil filter that is positioned so that filtration is optimized. Additionally needed is a design that allows a magnet to be associated with an oil filter that facilitates the manufacturing and installation process.

Thus, it is a principal object of this invention to provide an oil filter that uses a magnet to improve upon the state of the art.

Yet another object of the present invention is to enhance the filtration of metal particles from oil in an engine.

Another object of the present invention is to incorporate a magnet into an oil filter so that the manufacturing of the oil filter is simplified.

Yet another object of the present invention is to provide an oil filter that uses only a single magnet to filter metal particles.

These objects, improvements, and advantages will be discussed in detail in the specification.

### BRIEF SUMMARY OF THE INVENTION

The present invention is an oil filter that uses a magnet to filter metal particles as oil is processed through the oil filter. The oil filter is an elongated cylinder that is manufactured to filter oil when oil is processed through the cylinder. Attached to the base or rim of the cylinder is a magnet. The magnet can be manufactured separately from the oil filter or as part of the body of the filter and is preferably a rare earth magnet.

### BRIEF DESCRIPTION OF THE DRAWINGS

FIG. 1 is an exploded perspective view of the invention;

FIG. 2 is a perspective view of an alternative embodiment of the invention; and

FIG. 3 is a perspective view of an alternative embodiment of the invention.

### DETAILED DESCRIPTION OF THE PREFERRED EMBODIMENTS

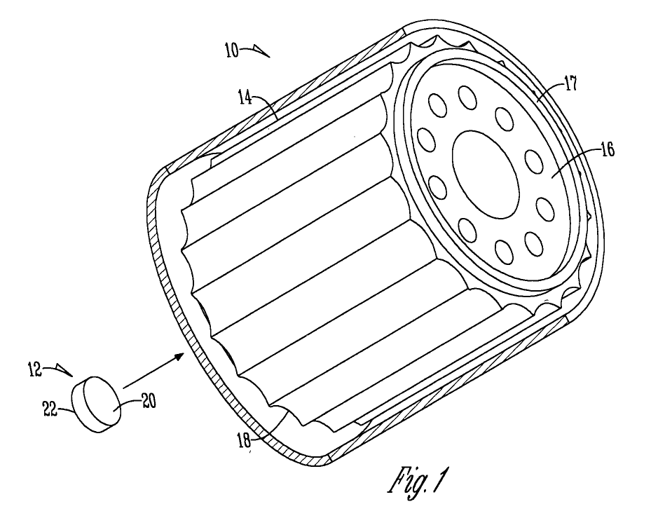

FIG. 1 shows an oil filter 10 and rare earth magnet 12. The oil filter 10 has a cylindrical body 14 and a top 16 with a rim 17 and is in fluid communication with an engine such that oil flows to the filter 10 through the top 16. The bottom or base 18 of oil filter 10 is enclosed to ensure that oil does not leak from the system. The interior of the oil filter is designed to receive and filter oil during the processing of the oil through the engine. The rare earth magnet 12 has a top 20 and a bottom 22 and is attached to the bottom 18 of the oil filter 10.

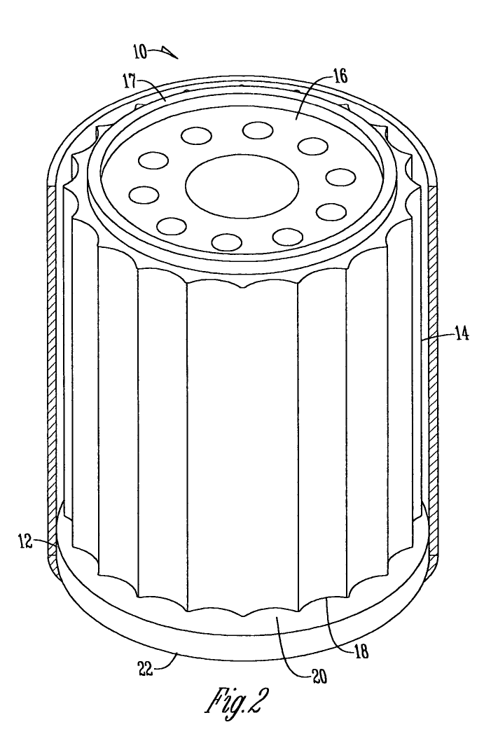

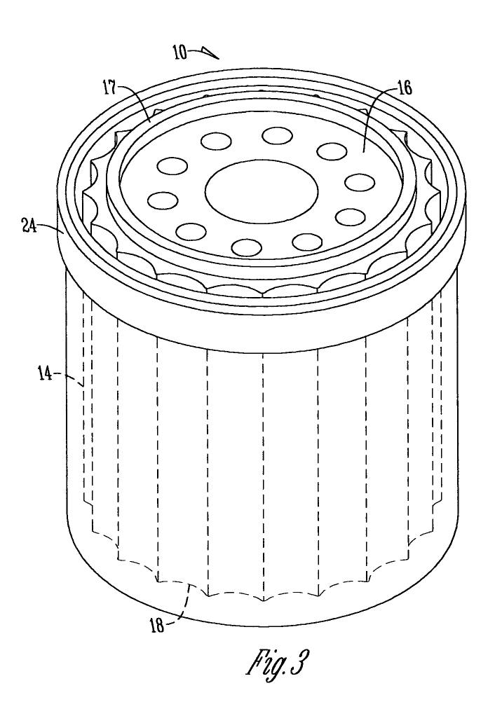

FIG. 2 shows an embodiment wherein the rare metal earth magnet 12 is manufactured to form the bottom 18 of cylindrical body 14 of oil filter 10. The rare earth magnet 12 is manufactured as part of the cylindrical body 14 by molding the rare earth magnet 12 and cylindrical body 14 together. FIG. 3 shows an alternate embodiment of the present invention. In FIG. 3 a rare earth magnet if formed as a hollow cylindrical ring and is placed around the rim 17 at the top 16 of the oil filter 10.

In operation, the oil filters 10 of FIGS. 1 and 2 have oil enter the oil filter 10 during the processing of oil in an engine. The oil enters the top 16 of the cylindrical body 14 of oil filter 10 and is filtered by the interior filtering system of oil filter 10. As the oil runs through the interior of the oil filter 10 the rare earth magnet 12 creates a magnetic field to attract excess metal particles to the bottom 18 of oil filter 10. The filtered oil then proceeds back out of the top 16 of oil filter 10 into the engine for use. The strength of the magnet field caused by the rare earth metal magnet 12, allows the magnet 12 to be placed at the bottom 18 of cylindrical body 14 and still effectively capture metal particles in the oil filter 10. Furthermore, the increased magnetic strength of the rare earth magnet 12 allows the oil filter 10 to trap more metal particles than previous oil filters.

In operation, the embodiment of the oil filter 10 as shown in FIG. 3, the oil flows into the top 16 of oil filter 10 the rare earth magnet sleeve 12 filters metal particles out of the oil at the rim 17 of the oil filter 10. Then the oil goes into the filter and remaining particles are filtered out of the oil. The oil then leaves the filter and once again, is filtered a final time by the magnet 12 to ensure an optimal filtering process.

Rare earth magnets of any type may be used such as neodymium iron boron type magnet or in the alternative a samarium cobalt type magnet may be used. It should be appreciated that although rare earth magnet material is prone to chipping and cracking, with the use of a coolant it can be abrasively ground to manufacture the magnet for the desired application of the present invention.

Thus, it should be appreciated that the oil filter of the present invention improves upon the state of the art. The filter is able to capture excess metal particles while using a rare earth magnet positioned at the bottom or rim of the oil filter. This allows the filter and magnet system to be easily manufactured and provide maximum filtration. Furthermore, when the rare earth magnet is located at the bottom of the filter, installation of the filter becomes simpler within the confined space of the vehicle.

It will be appreciated by those skilled in the art that other various modifications could be made to the device without the parting from the spirit in scope of this invention. All such modifications and changes fall within the scope of the claims and are intended to be covered thereby.

1. An oil filter for an engine comprising:
an elongated cylindrical filter having a first open end with a rim in fluid communication with the engine and a second closed end; and
a rare earth magnet surrounding the rim on the first open end of the filter.

2. The oil filter of claim 1 wherein the rare earth magnet is a samarium cobalt magnet.

3. The oil filter of claim 1 wherein the rare earth magnet is a neodymium iron boron magnet.

4. An oil filter for enhanced filtering of oil within an engine comprising:
an elongated cylindrical filter having an open end in fluid communication with the engine and a closed end with a bottom; and
a rare earth magnet attached to the bottom of the filter.

5. The oil filter of claim 4 wherein the rare earth magnet is a samarium cobalt magnet.

6. The oil filter of claim 4 wherein the rare earth magnet is a neodymium iron boron magnet.

7. An oil filter for enhanced filtering of oil within an engine comprising:
an elongated cylindrical filter having a first open end in fluid communication with the engine and a second closed end formed from a rare earth magnet.

8. The oil filter of claim 7 wherein the rare earth magnet is a samarium cobalt magnet.

9. The oil filter of claim 7 wherein the rare earth magnet is a neodymium iron boron magnet.
